(19) United States
(12) Patent Application Publication
(10) Pub. No.: US 2011/0030724 A1
(43) Pub. Date: Feb. 10, 2011

(54) Multifunction Pressure Washer

(76) Inventor: Gus Alexander, Inverness, IL (US)

Correspondence Address: COOK ALEX LTD, SUITE 2850, 200 WEST ADAMS STREET, CHICAGO, IL, 60606, US

(21) Appl. No.: 12/849,361

(22) Filed: Aug. 3, 2010

Related U.S. Application Data
(60) Provisional application No. 61/231,180, filed on Aug. 4, 2009.

(51) Int. Cl. B08B 3/00

(52) U.S. Cl. 134/6; 134/184

(57) ABSTRACT

A portable multifunction pressure washer including a diverter valve with first and second outlets, and an inlet which is fluidly connected to a fluid pump to receive pressurized fluid. A first cleaning element is connected to the housing and is fluidly connected to the first outlet and a second cleaning element is fluidly connected to the second outlet. A control element is movable between at least two positions in order to selectively direct pressurized fluid through to the first cleaning element or to the second cleaning element.

### CROSS REFERENCE TO RELATED APPLICATION

This application claims the benefit of U.S. Provisional Application No. 61/231,180, filed Aug. 4, 2009, which is incorporated herein by reference in its entirety.

### BACKGROUND

The present disclosure relates generally to a pressure washer and, more specifically, to a portable multifunction pressure washer which allows an operator to switch between two or more different cleaning elements, so as to enable more flexible usage and appropriate usage of the pressure washer during cleaning operations.

There are a variety of different types of washing devices which are commonly used to clean a variety of surfaces using high pressure fluid. Typically these devices are single-use machines which include a fluid pump and a power source, such as an engine or motor, to drive the pump and generate a pressurized liquid supply. With these devices, the pressurized liquid supply communicates with a single cleaning element, such as, a floor scrubber, wash broom, wash brush or a spray wand or gun. Each cleaning element allows the pressure washer operator to clean a particular type of surface in a particular manner. For example, a pressure washer with a floor scrubber includes a cleaning head or housing which the user typically moves along a floor surface and includes spray nozzles to direct pressurized fluid at a floor to be cleaned. When the pressure washer's cleaning element is a spray wand or gun, the user typically holds the wand or gun and directs the fluid at a surface to be cleaned.

Typically, such prior art pressure washers include only one cleaning element and therefore, are single-use machines with limited versatility or flexibility. For example, a pressure washer with a floor scrubber cannot be used to clean vertical surfaces, small or tight areas or irregularly shaped objects. Similarly, cleaning a large area such as a floor with a pressure washer having a spray wand or gun can be quite time consuming and less effective than using a floor scrubber.

While there are some pressure washers that attempt to combine a floor scrubber and a handheld wand into a single unit, these designs have a number of drawbacks. For example, as shown in U.S. Publication No. 200610254008 to Hahn et al., the pressurized fluid is directed to the floor scrubber via the handheld wand. A user is required to properly seat and connect the end of the wand into a fitting of the floor scrubber before the user can switch between using the two cleaning elements. Such a construction makes it difficult and time consuming for the user to switch between using the floor scrubber and handheld wand.

### SUMMARY

The subject matter disclosed herein is directed to a portable multifunction pressure washer including a fluid pump driven by a power source and a housing supporting a diverter valve with first and second outlets, and an inlet which is fluidly connected to the fluid pump to receive pressurized fluid. A first cleaning element is connected to the housing and is fluidly connected to the first outlet and a second cleaning element is fluidly connected to the second outlet. A control element is positioned on the housing and is movable between at least a first position and a second position. The control element is coupled to the diverter valve such that when the control element is in the first position pressurized fluid is directed through the first outlet and to the first cleaning element and when the control element is in the second position pressurized fluid is directed to the second outlet and to the second cleaning element.

### BRIEF DESCRIPTION OF THE DRAWINGS

FIG. 1 is a perspective view according to an example of a portable multifunction pressure washer.

FIG. 2 is a rear plan view of the pressure washer of FIG. 1.

FIG. 3 is a bottom plan view of the pressure washer of FIG. 1.

FIG. 4 is a schematic with a cross sectional view of the selector assembly of the pressure washer of FIG. 1, showing the selector assembly in a position in which fluid communication is established between a pump and a spray gun assembly.

FIG. 5 is a schematic with a cross sectional view of the selector assembly of the pressure washer of FIG. 1, showing the selector assembly in a position in which fluid communication is established between a pump and a floor scrubber assembly.

FIG. 6 is an exploded perspective view of the selector assembly of FIGS. 4 and 5.

FIG. 7 is a perspective view of an alternative example of a cleaning element for use with a multifunction pressure washer.

FIG. 8 is a perspective view of an alternative example of a selector assembly for use with a multifunction pressure washer.

FIG. 9 is a side view of the selector assembly of FIG. 8.

FIG. 10 is a cross sectional view of the selector assembly of FIG. 8 in a first position that defines a first fluid pathway between a pump and a first outlet.

FIG. 11 is a cross sectional view of the selector assembly of FIG. 8 in a second position that defines a second fluid pathway between a pump and a second outlet.

FIG. 12 is an exploded perspective view of the selector assembly of FIG. 8.

### DETAILED DESCRIPTION

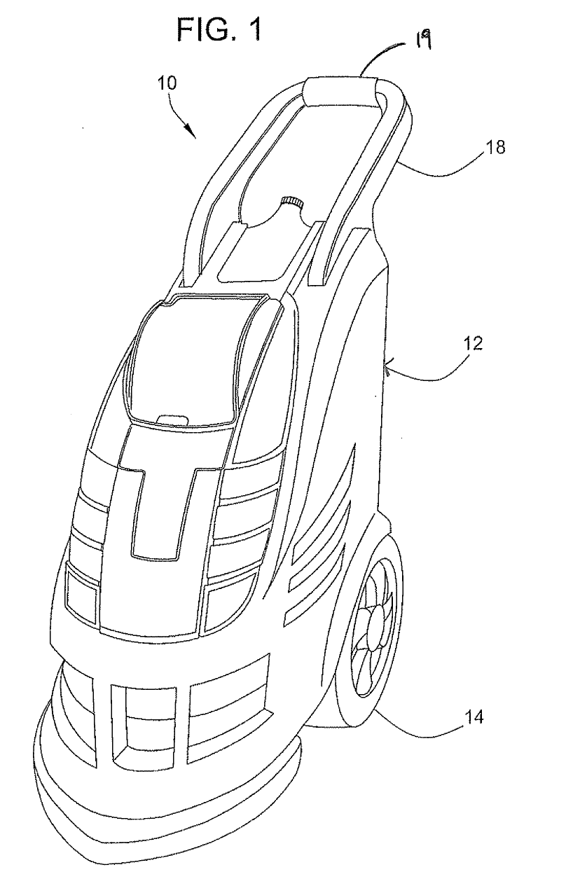

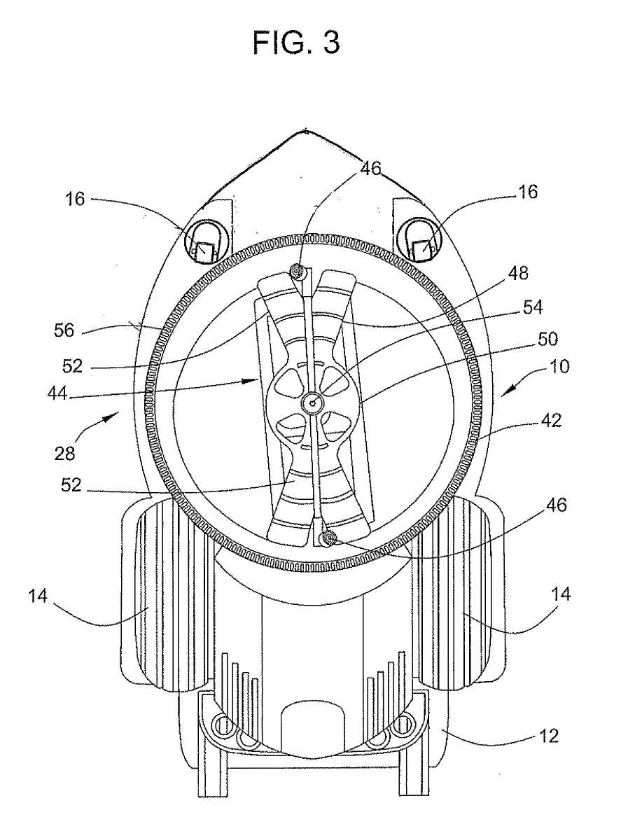

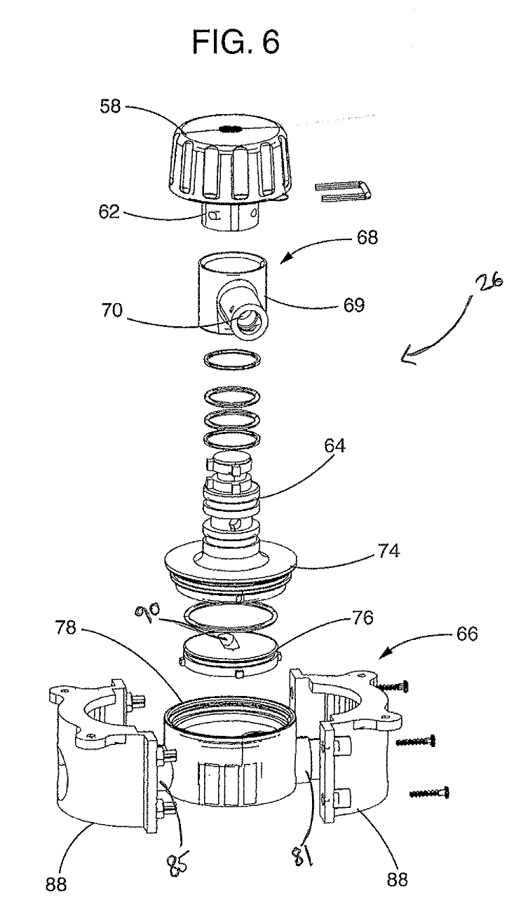

Turning to the drawings, FIGS. 1-6 illustrate a first example of a portable multifunction pressure washer 10 according to the present disclosure. The pressure washer 10 includes a housing 12 which in the illustrated example is constructed of molded plastic; however, it is appreciated that other methods of construction would be apparent to one skilled in the art. To permit the operator to move the pressure washer during use, the housing 10 is supported by rolling elements such as wheels, casters, rolling balls or the like. In the example illustrated in FIG. 3, the rolling elements include rear wheels 14 disposed near a rear of the housing 12 and casters 16 disposed near a front of the housing 12, in order to increase portability and maneuverability of the pressure washer. However, it will be appreciated that the type of rolling element and placement can be altered without departing from the scope or spirit of the present disclosure.

To facilitate movement of the pressure washer including lifting, carrying and tilting, the housing 12 includes a handle 18. In the illustrated example, the handle extends upwardly from the upper end of a rear portion of the housing and has an inverted U-shape that defines a horizontal gripping bar 19. The handle 18 may be height adjustable relative to the housing 12 to accommodate for different operator heights and may be collapsible for efficient space-saving storage.

In order to generate a pressurized liquid supply, the housing 12 includes a fluid pump 20 which is driven by a power source, such as, a gasoline powered engine or electric motor (not shown). It is appreciated that any conventional pump and engine or motor may be incorporated into the pressure washer 10. In the illustrated example, the power source is an electric motor which includes a power cord 24 for connection to an electric outlet. In addition, the power cord is retractable into the housing through an opening 25.

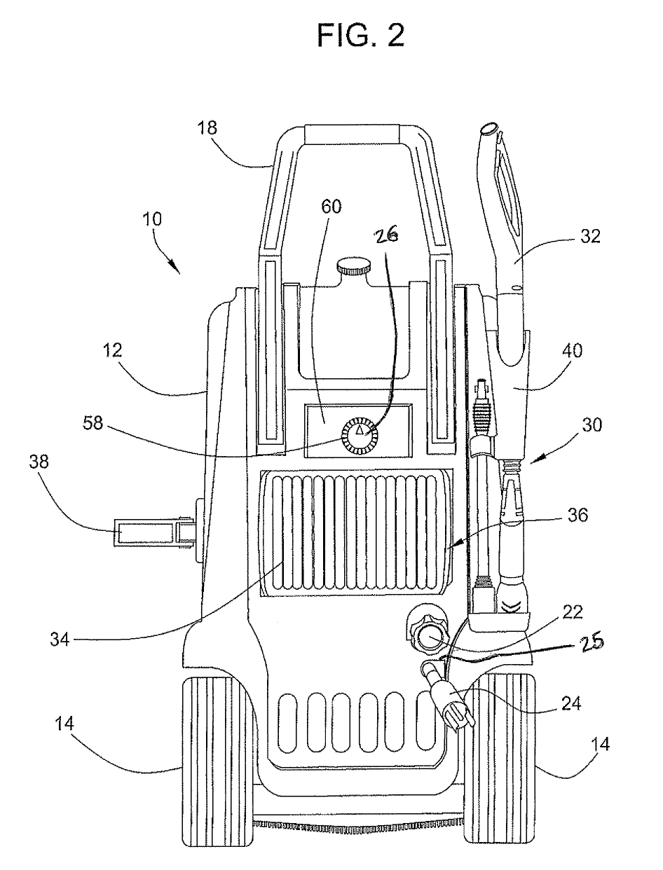

In order to provide fluid to the pump 20, a liquid supply source such as home water outlet is connected via a hose to inlet 22 of pump 20. In the illustrated example, the inlet protrudes from the rear of the housing (best seen in FIG. 2). However, it will be appreciated that the placement of the inlet can be altered without departing from the scope or spirit of the present disclosure.

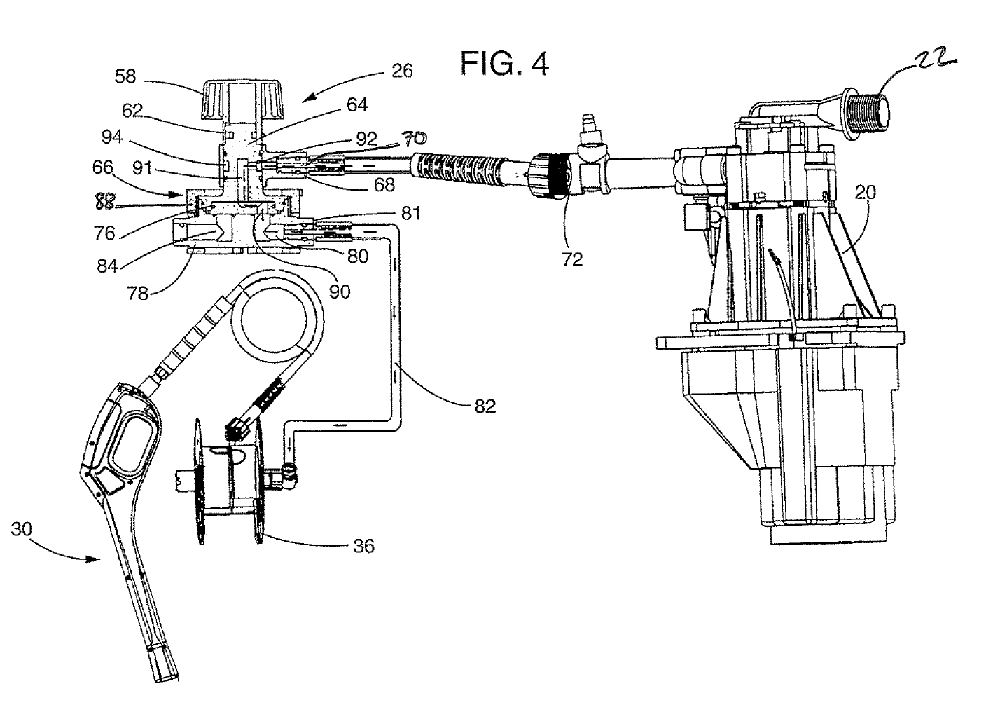

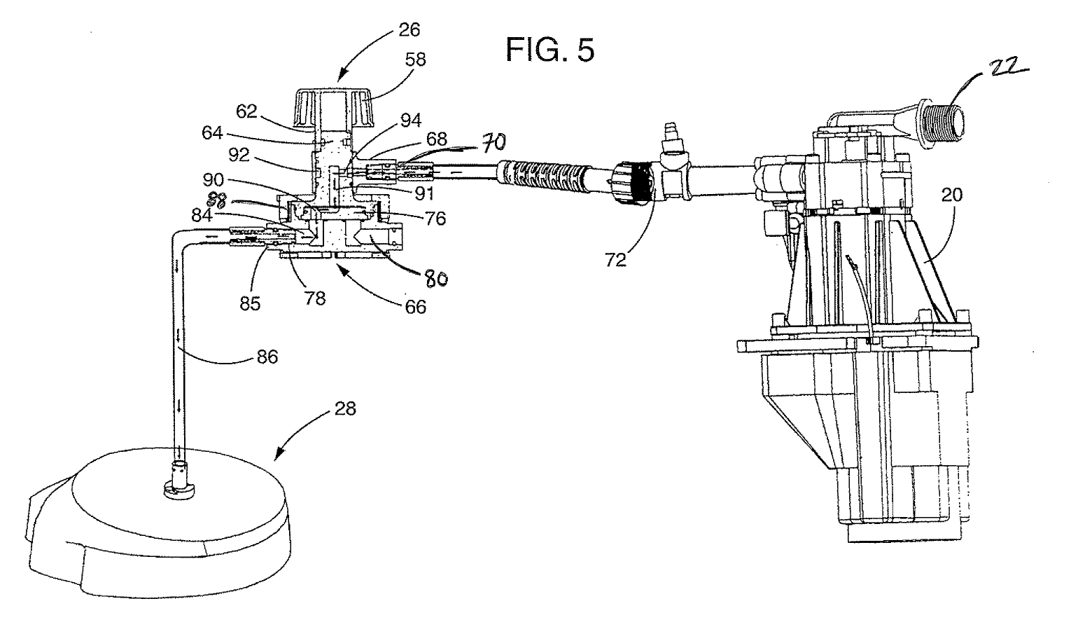

In accordance with one aspect of the present disclosure, the pressure washer 10 is adapted to allow an operator to quickly and easily switch between using two or more different cleaning elements. In particular, a selector assembly 26 (best seen in FIGS. 4 and 5) is provided which allows the operator to selectively direct pressurized fluid discharging from the pump 20 to one of two or more different cleaning elements. More specifically, the selector assembly 26 includes a control element 58 in connection with a diverter valve 66 to direct pressurized fluid to one of two or more cleaning elements.

The diverter valve 66 includes an inlet 70 and at least two outlets 81 and 85. The inlet of the diverter valve 66 is in fluid communication with a pump outlet 72 of the fluid pump 20 in order to receive pressurized fluid to be directed to a selected cleaning element. Each outlet 81, 85 is in fluid communication with a separate cleaning element and the diverter valve 66 is configured such that movement of the control element 58 allows the user to select which cleaning element receives the pressurized fluid without requiring the user to position one cleaning element to direct fluid into another cleaning element.

In the example illustrated in FIG. 2, the control element 58 is a knob which can be rotated by an operator between at least two positions and is positioned on a control panel 60 on the rear side of the housing 12. It will be appreciated that other placements and configurations of a control knob for a selector assembly, for example a switch, may be used and not depart from the scope or spirit of the present disclosure.

In the illustrated example, the diverter valve 66 includes a control stem 64, a pump connector 68, a rotatable disc member 76, and a valve body 78 all of which are held in an assembled configuration by a housing 88. The control stem 64 is connected to the control element 58 by seating an upper end of the control stem 64 within a recess of a depending stem 62 of the control element 58. The control element 58 and control stem 64 are connected in such a manner that the rotation of the control element 58 causes rotation of the control stem 64.

The pump connector 68 is the structure the pump 20 communicates with to introduce pressurized fluid into the diverter valve 66. The pump connector 68 is a hollow structure which includes a body portion 69 sized to fit over the control stem 64 in such a way that the control stem 64 is rotatable relative to the pump connector 68. As shown in FIGS. 4 and 5, the pump connector further includes an inlet portion 70 which extends radially from the body portion 69 and is in fluid communication with the pump outlet 72 of the fluid pump 20.

In order to direct pressurized fluid through the control stem 64, inlet 70 of the pump connector 68 is in selective fluid communication with at least one of radial passageways 92 and 94 of the control stem (see FIGS. 4 and 5). Thus, the control element 58 can be manipulated to rotate the control stem 64 and to align either radial passageway 92 or radial passageway 94 with inlet 70 of the pump connector 68. Passageways 92 and 94 are further in selective fluid communication with a longitudinal passageway 91 which extends through the control stem.

The longitudinal passageway 91 extends through the control stem and communicates with a fluid passageway 90 of a rotating disc member 76. An enlarged portion 74 of the control stem 64 interacts with the rotatable disc member 76 in such a way that rotation of the control stem 64 drives rotation of the disc member 76. The fluid passageway 90 defined through the disc member 76 allows pressurized fluid to be selectively delivered to separate cleaning elements. More specifically, in response to rotation of the control element 58 and ultimately rotation of the control stem 64, the fluid passageway 90 of the disc member 76 may be selectively aligned with the respective outlets 81, 85 of the diverter valve 76.

In the illustrated example, the valve body 78 includes first and second fluid pathways 80, 84, respectively. The first fluid pathway 80 communicates with a first outlet 81 which further communicates with a first cleaning element. The second fluid pathway 84 communicates with a second outlet 85 which further communicates with a second cleaning element. It will be appreciated that while the illustrated diverter valve 66 discloses only two outlets, additional outlets may be incorporated to communicate with additional cleaning elements.

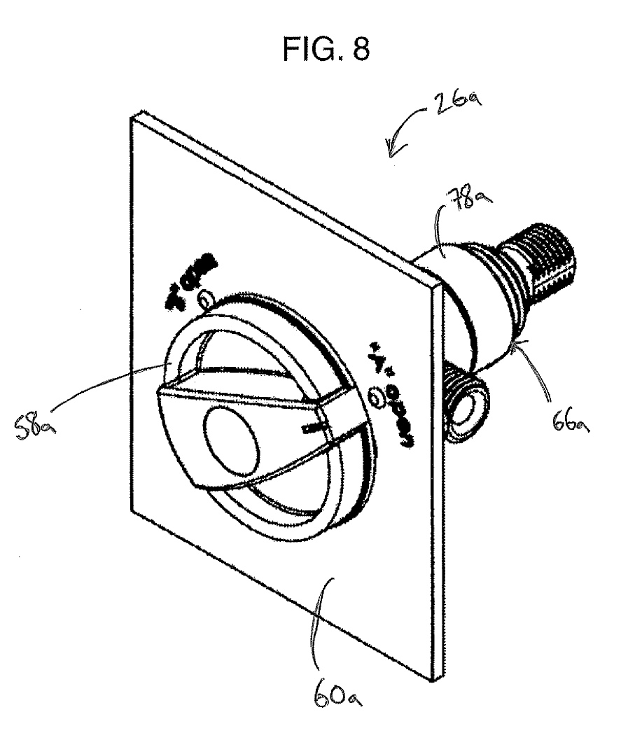

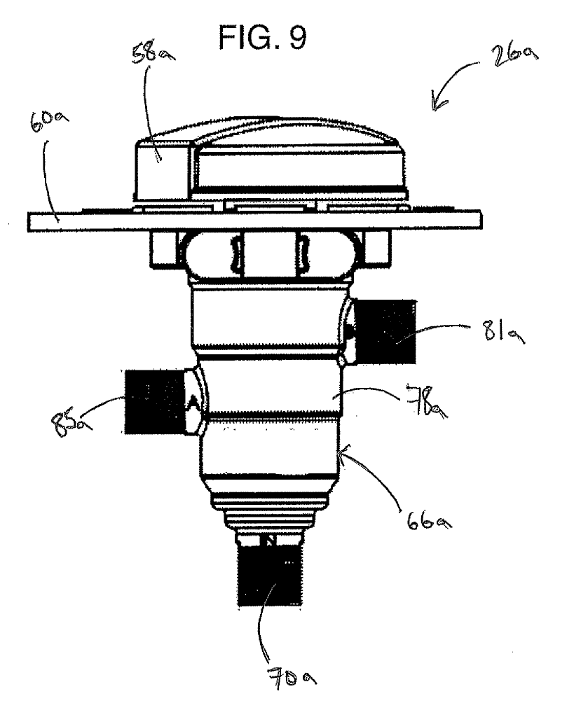

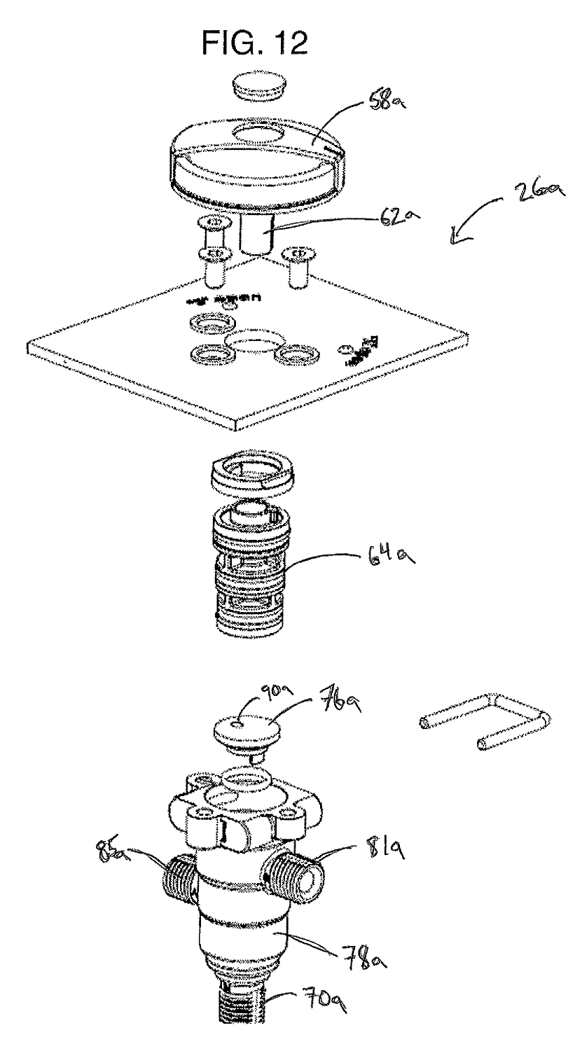

FIGS. 8-12 disclose an alternative example of a selector assembly 26a which can be used with the pressure washer of the present disclosure. Like the first example, the selector assembly 26a includes a control selector 58a in the form of a knob in rotatable connection with a diverter valve 66a. The diverter valve 66a includes a control stem 64a, a disc member 76a, and a valve body 78a. The control stem 64a is connected to the control element 58a by seating a depending stem 62a of the control element 58a within a recess of the control stem 64a. The control element 58a and control stem 64a are connected in such a manner that the rotation of the control element 58a causes rotation of the control stem 64a.

The valve body 78a is the structure the pump communicates with to introduce pressurized fluid into the diverter valve 66a and further communicates with the cleaning elements. The valve body 78a is a hollow structure which includes an inlet portion 70a which is in fluid communication with a fluid pump, such as pump 20 and two outlets 81a and 85a, each of which is in fluid communication with a respective cleaning element. The control stem 64a and the disc member 76a are positioned within the valve body 78a.

A fluid passageway 90a defined through the disc member 76a allows pressurized fluid to be selectively delivered to separate cleaning elements. The control stem 64a includes passageways which can be selectively aligned with passageway 90a in order to deliver pressurized fluid from the inlet 70a to one of the outlets 81a and 85a and ultimately one of the cleaning elements.

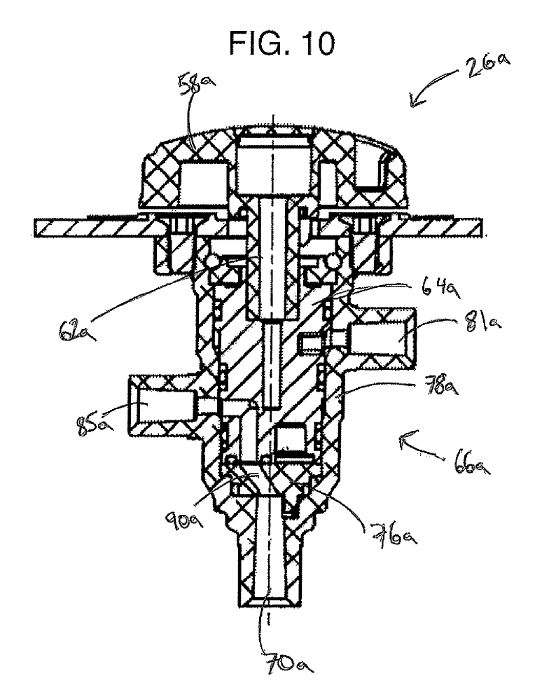

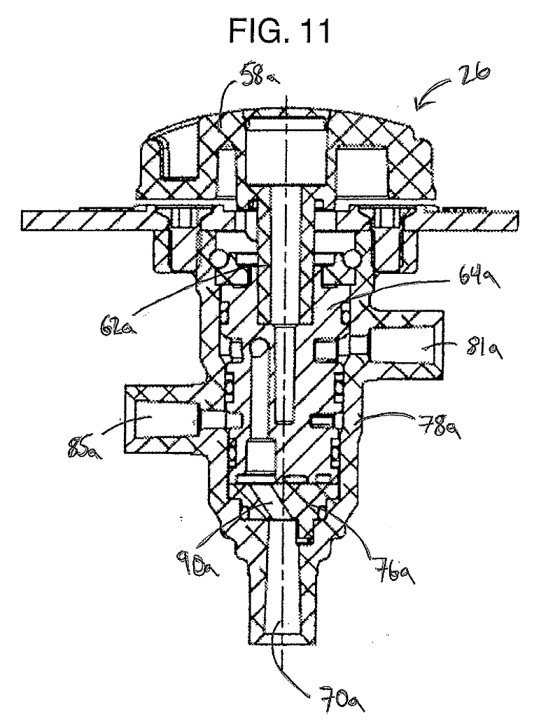

FIG. 10 illustrates the selector assembly 26a in a first position wherein pressurized fluid is delivered from the inlet 70a of the diverter valve 66a and out through outlet 85a, to a first cleaning element. FIG. 11 illustrates the selector assembly 26a in a second position wherein pressurized fluid is delivered from the inlet 70a of the diverter valve 66a and out through outlet 81a, to a second cleaning element.

### Cleaning Elements

It is understood that a variety of devices can be used as a cleaning element, for example, a floor scrubber, a wash broom, a wash brush or a spray gun. In the example illustrated in FIGS. 1-6, the first cleaning element is a floor scrubber assembly 28 and the second cleaning element is a spray wand or gun 30.

### Floor Scrubber

The floor scrubber assembly 28 of the example illustrated in FIG. 3, includes a downwardly opening cleaning chamber 42 defined in the lower portion of the housing 12. The floor scrubber assembly 28 further includes a spray nozzle assembly 44 positioned within the cleaning chamber 42 in order to selectively direct pressurized fluid onto a floor surface to be cleaned. In this instance, the spray nozzle assembly 44 includes a pair of spray nozzles 46 at diametrically opposed ends of a rotary arm 48. The spray nozzles 46 may be of a conventional type for directing a flat spray pattern in impinging relation to a floor surface. The rotary arm 48 is in the form of a pair of radial wings extending from diametrically opposed sides of a central hub 50 generally parallel to the floor surface. Each wing has a fluid supply passageway 52 communicating between the hub 50 and spray nozzles 46.

The housing 12 supports a downwardly depending shaft 54 which supports the spray nozzle assembly 44 and allows rotational movement as an incident to the direction of pressurized liquid spray. The spray nozzles 46 are oriented in an angled relation to the floor surface such that the direction of pressurized fluid flow through the spray nozzles 46 imparts tangential forces for rotating the spray nozzle assembly 44 relative to the shaft 54. For enhancing the scrubbing action with the floor, the perimeter of the cleaning chamber 42 may include depending brush bristles 56. Additional details regarding the configuration of the floor scrubber assembly 28 are disclosed in U.S. Pat. No. 7,770,254, the disclosure of which is incorporated in its entirety herein by reference.

### Spray Gun

In the illustrated example, a spray gun assembly 30 includes a spray gun 32 that is connected to a high pressure hose 34. The hose 34 is then fluidly connectable with one of the outlets 81 or 85 of the diverter valve 66. A nozzle of any desired type can be mountable on the spray gun 32 which typically includes a hand operated trigger valve for allowing an operator to controllably direct a stream of pressurized fluid toward a surface for cleaning. The hose 34 can have a reinforced construction, such as is disclosed in U.S. Pat. No. 5,964,409, the entire disclosure of which is incorporated herein by reference. The hose 34 and spray gun 32 each may be provided with conventional fittings and couplings to effect appropriate fluid tight connections therebetween.

For storing the hose 34, the pressure washer housing 12 may be equipped with a hose reel which is preferably rotatable. In the example illustrated in FIG. 2, the pressure washer housing 12 includes an internal hose reel 36 for storing the hose 34. A handle 38 is associated with the reel 36 to facilitate winding and unwinding of the hose 34. Further, the pressure washer housing may include a receptacle 40 for conveniently and efficiently storing the spray gun 32 when it is not in use.

### Wash Broom

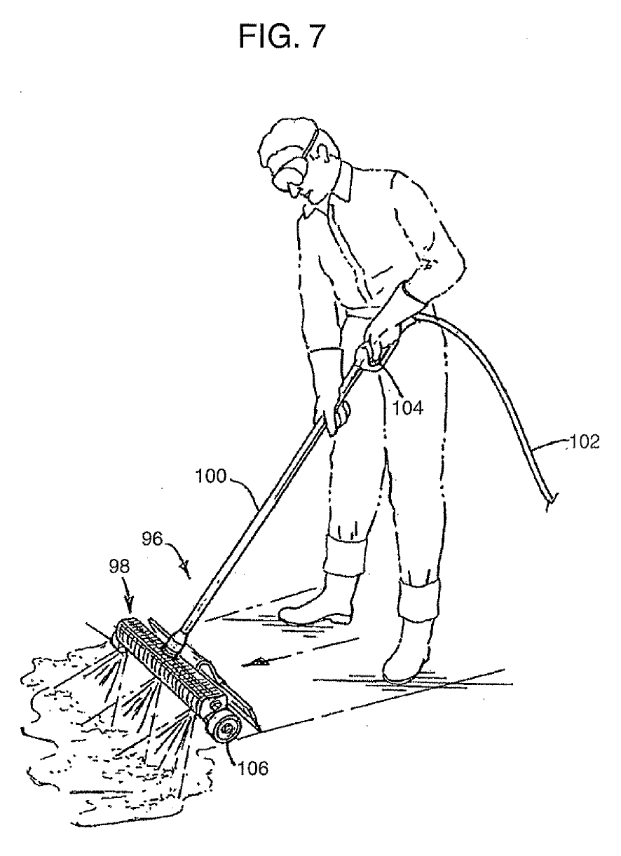

Instead of or in addition to the spray gun assembly 30 or floor scrubber assembly 28, the pressure washer 10 of the present disclosure could be equipped with a wash broom assembly 96. As illustrated in FIG. 7, the wash broom assembly 96 includes a spray head 98 that is moveable along a floor surface and a handle 100 that is arranged or arrangeable in upstanding relation to the spray head 98 for moving the wash broom along a floor surface. A high pressure hose 102 connects the wash broom to one of the outlets of the diverter valve. A wand or gun 104 can be provided at the end of the hose 102 or on the handle 100. The wand typically includes a trigger valve to allow the operator to selectively control the supply of pressurized fluid to the spray head 98 during a cleaning operation.

As shown, the spray head 98 has an elongated body that has a longitudinal axis oriented transverse to the line of movement of the spray head. The elongated body can define a manifold passageway that communicates with a plurality of spray nozzles. The spray nozzles can be of a conventional type that are configured to provide a high pressure fluid spray for effective floor cleaning. The wash broom assembly 96 may further include wheels 106 in order to support the spray head 98 and permit rolling movement on the floor surface to be cleaned. Additional details regarding the wash broom assembly 96 can be found in U.S. Pat. No. 7,217,053, the disclosure of which is incorporated in its entirety herein by reference.

It will be appreciated that additional types of cleaning elements can be used in connection with the diverter valve without departing from the scope or spirit of the present disclosure. For example, wash brushes similar to the ones disclosed, in U.S. Pat. Nos. 6,915,541 and 7,665,171, the disclosure of which are incorporated in their entireties herein by reference, may also be used.

Alternatively, the housing 12 of the pressure washer 10 could be configured to support an elongated spray head, as used with the wash broom assembly 96, rather than the rotating spray nozzle assembly of a floor scrubber assembly 28. With such an arrangement, the wash broom assembly would be fixed to the housing instead of the floor scrubber and the second cleaning element could be provided by, for example, a spray gun assembly 30.

In use, the operator of the pressure washer of the present disclosure simply manipulates the control element 58 (for example, by turning a knob) of the selector assembly 26 to selectively change which cleaning element receives the pressurized fluid generated by the pump 20. More specifically, the control element 58 is moved between a first position which allows pressurized fluid to be directed to a first cleaning element and a second position which allows pressurized fluid to be directed to a second cleaning element. The manipulation of the control element 58 alters the configuration of the diverter valve 66 such that fluid is directed from one cleaning element to another cleaning element. In addition, in a preferred example, all of the cleaning elements, pump, and power source are contained or attached to a single housing. Such a pressure washer enables an operator to simply and efficiently switch between at least two cleaning elements without having to use one of the cleaning elements to establish a connection and ultimately deliver pressurized fluid to a second cleaning element.

It will be understood that there are numerous modifications of the illustrated examples described above which will be readily apparent to one skilled in the art, such as many variations and modifications of the selector assembly and/or its components (control element and diverter valve) including combinations of features disclosed herein that are individually disclosed or claimed herein, explicitly including additional combinations of such features, or alternatively other types of selector assemblies. Also, there are many possible variations in the materials and configurations. These modifications and/or combinations fall within the art to which this present disclosure relates and are intended to be within the scope or spirit of the claims, which follow.

I claim:

1. A portable multifunction pressure washer comprising:
a fluid pump driven by a power source;
a housing supporting a diverter valve with first and second outlets, and an inlet fluidly connected to the fluid pump to receive pressurized fluid;
a first cleaning element connected to the housing and fluidly connected to the first outlet;
a second cleaning element fluidly connected to the second outlet; and
a control element positioned on the housing and movable between at least a first position and a second position;
wherein the control element is coupled to the diverter valve and when the control element is in the first position pressurized fluid is directed through the first outlet and to the first cleaning element and when the control element is in the second position pressurized fluid is directed to the second outlet and to the second cleaning element.

2. The pressure washer of claim 1, wherein one of the first or second cleaning elements includes a downwardly opening cleaning chamber defined in the housing, the chamber supporting a spray nozzle assembly which includes a plurality of spray nozzles in fluid communication with the one of the first and second outlets when the control element is in one of the first or second positions.

3. The pressure washer of claim 1, wherein one of the first or second cleaning elements includes a spray gun fluidly connected to the one of the first or second outlets via a hose and receives pressurized fluid when the control element is in one of the first or second positions.

4. The pressure washer of claim 1, wherein one of the first or second cleaning elements includes a wash broom fluidly connected to the one of the first or second outlets via a hose for directing pressurized fluid when the control element is in one of the first or second positions.

5. The pressure washer of claim 1, wherein the first cleaning element includes a downwardly opening cleaning chamber defined in the housing, the chamber supporting a spray nozzle assembly which includes a plurality of spray nozzles in fluid communication with the first outlet when the control element is in the first or position.

6. The pressure washer of claim 5, wherein the second cleaning element includes a spray gun fluidly connected to the second outlet via a hose and receives pressurized fluid when the control element is in the second position.

7. The pressure washer of claim 5, wherein one of the second cleaning element includes a wash broom fluidly connected to the second outlet via a hose for directing pressurized fluid when the control element is in the second position.

8. The pressure washer of claim 1, wherein the control element is a knob.

9. The pressure washer of claim 3, wherein the housing further includes a hose reel.

10. The pressure washer of claim 4, wherein the housing further includes a hose reel.

11. The pressure washer of claim 1, wherein the housing supports rolling elements to permit rolling movement along the floor surface.

12. A method of using a portable multifunction pressure washer comprising the steps of:
providing a pressure washer including
a fluid pump driven by a power source;
a housing supporting a diverter valve with first and second outlets, and an inlet fluidly connected to the fluid pump to receive pressurized fluid;
a first cleaning element connected to the housing and fluidly connected to the first outlet;
a second cleaning element fluidly connected to the second outlet; and
a control element positioned on the housing which is coupled to the diverter valve;
positioning the control element in a first position to direct pressurized fluid through the first outlet and to the first cleaning element; and
positioning the control element in a second position to direct pressurized fluid through the second outlet and to the second cleaning element.

13. The method of claim 12, wherein one of the first or second cleaning elements includes a downwardly opening cleaning chamber defined in the housing, the chamber supporting a spray nozzle assembly which includes a plurality of spray nozzles in fluid communication with the one of the first and second outlets when the control element is in one of the first or second positions.

14. The method of claim 12, wherein one of the first or second cleaning elements includes a spray gun fluidly connected to the one of the first or second outlets via a hose and receives pressurized fluid when the control element is in one of the first or second positions.

15. The method of claim 12, wherein one of the first or second cleaning elements includes a wash broom fluidly connected to the one of the first or second outlets via a hose for directing pressurized fluid when the control element is in one of the first or second positions.

16. The method of claim 12, wherein the first cleaning element includes a downwardly opening cleaning chamber defined in the housing, the chamber supporting a spray nozzle assembly which includes a plurality of spray nozzles in fluid communication with the first outlet when the control element is in the first or position.

17. The method of claim 16, wherein the second cleaning element includes a spray gun fluidly connected to the second outlet via a hose and receives pressurized fluid when the control element is in the second position.

18. The method of claim 16, wherein one of the second cleaning element includes a wash broom fluidly connected to the second outlet via a hose for directing pressurized fluid when the control element is in the second position.

19. The method of claim 8, wherein the housing supports rolling elements to permit rolling movement along the floor surface.
